(19) United States
(12) Patent Application Publication
(10) Pub. No.: US 2015/0155921 A1
(43) Pub. Date: Jun. 4, 2015

(54) MIMO SIGNAL TRANSMISSION AND RECEPTION DEVICE AND SYSTEM COMPRISING AT LEAST ONE SUCH DEVICE

(71) Applicant: THOMSON LICENSING, Issy de Moulineaux (FR)

(72) Inventors: Ali Louzir, Rennes (FR); Jean-Yves Le Naour, Pace (FR); Dominique Lo Hine Tong, Rennes (FR); Philippe Minard, Saint Medard Sur llle (FR); Jean-Luc Robert, Betton (FR)

(21) Appl. No.: 14/405,592

(22) PCT Filed: May 31, 2013
(86) PCT No.: PCT/EP2013/061318

§ 371 Date: Dec. 4, 2014

(30) Foreign Application Priority Data
Jun. 7, 2012 (FR) 1255300

(51) Int. Cl. H04B 7/04; H04W 72/04; H04B 7/06; H04B 7/08

(52) U.S. Cl. CPC H04B 7/0413; H04B 7/0491; H04B 7/0814; H04W 72/046; H04B 7/0697; H04B 7/046

(57) ABSTRACT

The invention relates to a device for the transmission and/or reception of signals in an MIMO system consisting of:
a MIMO module consisting of N inputs/outputs to deliver or receive N signals, where N≧2,
an antenna system for transmitting or receiving said N signals, said system consisting of at least one antenna with M angular sectors in a horizontal plane, said M angular sectors sensitively not covering each other and together forming a global angular sector of 360°, and
switching means, mounted between the MIMO module and the antenna system, to connect P angular sectors of said multi-sector antenna, where 1≦P<M, with each of the N inputs/outputs of the MIMO module according to a switching diagram determined using control means in accordance with a criterion representing the quality of the reception of signals by said device or another device.

### TECHNICAL FIELD

The present invention relates to the transmission and reception of signals in a wireless, multi-antenna MIMO (Multiple Input Multiple Output) transmission system. The invention can be applied in a number of fields, such as in the field of high-bitrate home multimedia networks.

### PRIOR ART

Current WiFi technology, even that which corresponds to the most recent standard, does not provide the same coverage quality in a home as it does in a wired network. This problem cannot be solved by increasing transmission power as, with the rise of ecology, it has become necessary to design signal transition equipment that is both robust against interference and low-energy consuming, and that emits as little electromagnetic radiation as possible. These requirements apply particularly to equipment frequently used in domestic environments, for example home gateways and set-top boxes.

The technology used most frequently in this equipment to transmit signals is MIMO technology. This technology is known to increase transmission capacities by multiplying signal transmission paths and improve the robustness of transmission using spatial multiplexing and spatio-temporal coding techniques.

MIMO technology involves transmitting and receiving signals using a plurality of transmission channels with different characteristics to obtain separate signals and therefore increase the probability of at least one signal not being affected by fading. Signals are received or transmitted via a plurality of radio channels associated with a plurality of antennas.

For example, it is known from US2010/119002, an antenna system with one or several multi sector antennas where each sector is associated with a classical MIMO device.

The speed of the signals transmitted or received by the device may be increased by increasing the device's number of radio channels at the expense of energy consumption. Energy consumption generally increases exponentially with the number of radio channels. The energy consumption of each radio channel essentially results from the power amplifier, which consumes around 1 W due to the low energy efficiency of the OFDM modulation used in WiFi, which forces the amplifier to function well below saturation with increased back-off.

It is, moreover, well known that MIMO technology becomes less efficient in environments dominated by interference. And yet, with the constantly increasing amount of wireless equipment in homes, it has become essential to improve this technique for the transmission of signals in domestic environments.

An MIMO beamforming technique, illustrated in FIG. 1, has therefore been developed for MIMO transmission in noisy environments. As shown in FIG. 1, this solution uses a plurality of omnidirectional antennas connected to the inputs/outputs of the MIMO chip. These antennas are controlled together to obtain a radiation pattern with maximal values in the desired propagation directions and minimal values in the unwanted propagation directions. According to this technique, the form of the radiation pattern is obtained through signal processing in the MIMO chip.

Although this technique is used to obtain the desired radiation patterns, this solution is inadequate for the following reasons:
during reception, any jammers and interferences picked up by the equipment's omnidirectional antennas are always present on radio channels and lead to saturation, dynamic linearity and noise problems, which deteriorate the receiver's sensitivity,
in addition, irrespective of the calculation power allocated to the MIMO chip for beamforming, the radiation pattern that can be achieved depends greatly on the number of antennas (or radiation elements), the geometric availability of antennas in relation to each other and the performances of each antenna in relation to each other; indeed, a relatively high minimal number of antennas is generally required to obtain the desired radiation pattern form; but, increasing the number of antennas, of which there can be up to 8 in the standard Wifi 11n case, means increasing the number of radio transmission and reception channels in the MIMO chip, which increases the cost and consumption of the equipment,
moreover, the geometry of the network of antennas and the type of antenna are determined in the circuit integration phase and are often dependent on the form and size of the printed circuit card and the space remaining on this card for the antennas, which means that certain geometries are not possible.

### DESCRIPTION OF THE INVENTION

One purpose of the invention is to provide a multi-antenna device capable of transmitting and receiving MIMO signals to overcome some or all of the aforementioned disadvantages.

More specifically, a purpose of the invention is to provide a multi-antenna device capable of transmitting and receiving MIMO signals that is efficient in terms of speed and robust in environments dominated by interferences, and which transmits the least possible electromagnetic radiation into the environment in which it is placed.

For this purpose, the invention proposes to use the cluster propagation phenomenon illustrated in FIG. 2. This figure represents the angles of departure and angles of arrival, in terms of a MIMO device's antennas, in signals being propagated inside a building. These angles are presented in the horizontal plane (plane H) and vertical plane (plane V) of the antenna. As shown in this figure, signal energy is essentially propagated in a reduced number of directions known as prioritized directions. This means that, from the receiver side, the radiations arriving at the antennas with significant energy are found in a limited number of angular sectors in plane H and plane V and, when the transmission paths of these radiations are followed to the transmitter, these radiations also correspond to radiations transmitted in a limited number of angular sectors in plane H and plane V. If plane H is cut into angular sectors of around 60° as illustrated h FIG. 3, this shows, in this propagation example, that the significant radiations received by the receiver are present in the angular sectors [0°,60°], [—180° 120°] and [−60°]. These radiations are transmitted in the transmitter in angular sectors [0°,60°], [120°,180°] and [−180°,−120] of plane H (Horizontal) For all of these sectors, in transmission and reception, the opening in plane V (Vertical) is around 60° and corresponds to the sector [−30°,30°] of plane V The radiations transmitted in other angular sectors do not reach, or only very partially reach, the receiver. The energy of these sectors is therefore wasted and unnecessarily contributes to increasing background noise and interferences.

Also, according to the invention, it is proposed to replace the omnidirectional antennas of the MIMO signal transmission and reception devices with controlled multi-sector antennas to function solely in angular sectors corresponding to the clusters identified for the environment in which they are present.

The invention is therefore intended for a signal transmission and/or reception device in a MIMO system consisting of:
a MIMO module consisting of N inputs/outputs to deliver or receive N signals, N being greater than or equal to 2;
an antenna system to transmit or receive said N signals,

characterized in that the antenna system consists of at least one so-called multi-sector antenna, with M angular sectors in a horizontal plane capable of selectively receiving and/or transmitting said N signals in one or more of said M angular sectors, said M angular sectors not overlapping each other and together forming a global angular sector of 360 degrees, where M>N,

and in that the device also consists of switching means, mounted between the MIMO module and the antenna system to connect each of the N inputs/outputs of the MIMO module with P angular sectors of the at least one multi-sector antenna, where 1≦P<M, according to a switching diagram determined using control means in accordance with a criteria representing the quality of the reception of signals by said device or another device.

As such, according to the invention, the device transmits and/receives the N signals in a reduced number (=P) of angular sectors from the M angular sectors of the multi-sector antenna. As such, in transmission, the device does not transmit signals in every direction, but only in the predefined prioritized directions, which reduces the quantity of electromagnetic waves transmitted and concentrates the energy transmitted in the prioritized directions. In reception, the device only receives the signals from these prioritized directions, which reduces the cost of signal processing as well as the energy consumption of the device.

According to a first embodiment, the antenna system consists of N multi-sector antennas with M angular sectors and the switching means consisting of N switching circuits, each input/output of the MIMO module being connected to one of said N multi-sector antennas via one of said N switching circuits.

Each of said N multi-sector antennas includes Q inputs/outputs, Q being less than or equal to 2^{M}−1, each of said Q inputs/outputs being connected to a specific combination of angular sectors of the multi-sector antenna.

Advantageously, for each multi-sector antenna, no more than D angular sectors are connected via a switching circuit to an input/output of the MIMO module, where D<M. The number D corresponds to the maximum number of prioritized directions accepted by the device. For example, it can be considered that the device will use a maximum of 3 prioritized directions. D can therefore be fixed at 3. In this case, it is not necessary for the antennas to contain 2^{M}−1 inputs.

$$Q = {\sum }_{A = 1}^{D} \frac{M !}{A ! ( M - A ) !}$$

inputs/outputs may therefore suffice for the antennas.

Advantageously, M is at least equal to 4 and D is at most equal to 3.

According to a second embodiment, the antenna system consists of a multi-sector antenna with M angular sectors, where M>N, and the switching means consist of a switching circuit, said multi-sector antenna consisting of M inputs/outputs, each one connected to an angular sector of said antenna, said switching circuit being intended to selectively connect N antenna inputs/outputs to N inputs/outputs of the MIMO module. This embodiment is sub-optimal but reduces the number of device components.

Regardless of the embodiment, the number M of angular sectors of the multi-sector antennas is preferably equal to 6 as it has been discovered that, statistically, the angular opening of a cluster in plane H is typically 60°. 6 sectors are therefore typically required to cover the entire space (360°). Moreover, each sector has an angular opening in the vertical plane of 60°. In certain situations, it may be worth increasing the number of sectors, but 6 sectors represents a good compromise in terms of complexity-performance and cost-performance.

According to the invention, the M angular sectors of said at least one multi-sector antenna present identical openings in a vertical plane. The M angular sectors each present an opening of at least 120° between the −60° and +60° angles in the vertical plane. Preferably, they each present an opening of at least 60° between the −30° and +30° angles in the vertical plane.

Experts in the field may note other advantages when studying the following examples, illustrated in the figures appended, provided by way of example.

### BRIEF DESCRIPTION OF THE FIGURES

FIG. 1 represents the diagram of a MIMO signal transmission device implementing a beamforming technique,

FIG. 2 shows, in diagram form, the angle of departure and the angle of arrival in plane H and plane V of the signals transmitted and received in a domestic environment,

FIG. 3 represents the diagrams of FIG. 2 in which prioritized signal propagation directions have been identified,

FIG. 4 represents a diagram of a first embodiment for a device according to the invention,

FIG. 5 represents a diagram of a second embodiment for a device according to the invention,

FIG. 6 illustrates the functioning of a MIMO system consisting of two devices in accordance with FIG. 4 in the case where M=6, N=2 and D=2, and

FIG. 7 illustrates the functioning of a MIMO system consisting of two devices in accordance with FIG. 5 in the case where M=6, N=2 and D=2.

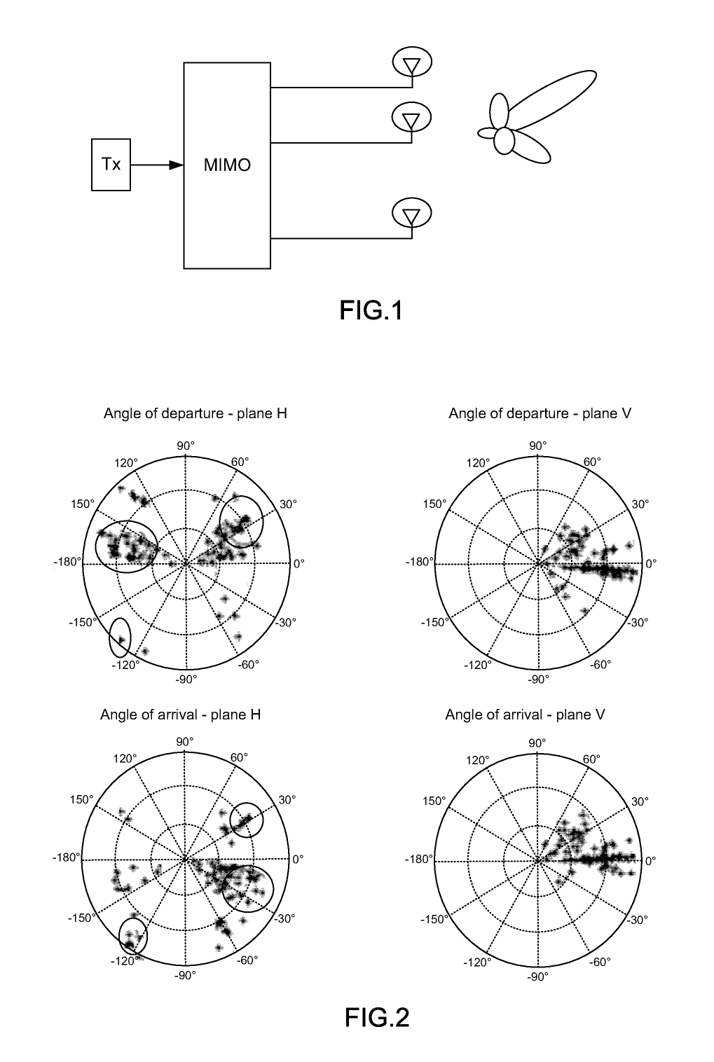

### DETAILED DESCRIPTION OF AN EMBODIMENT

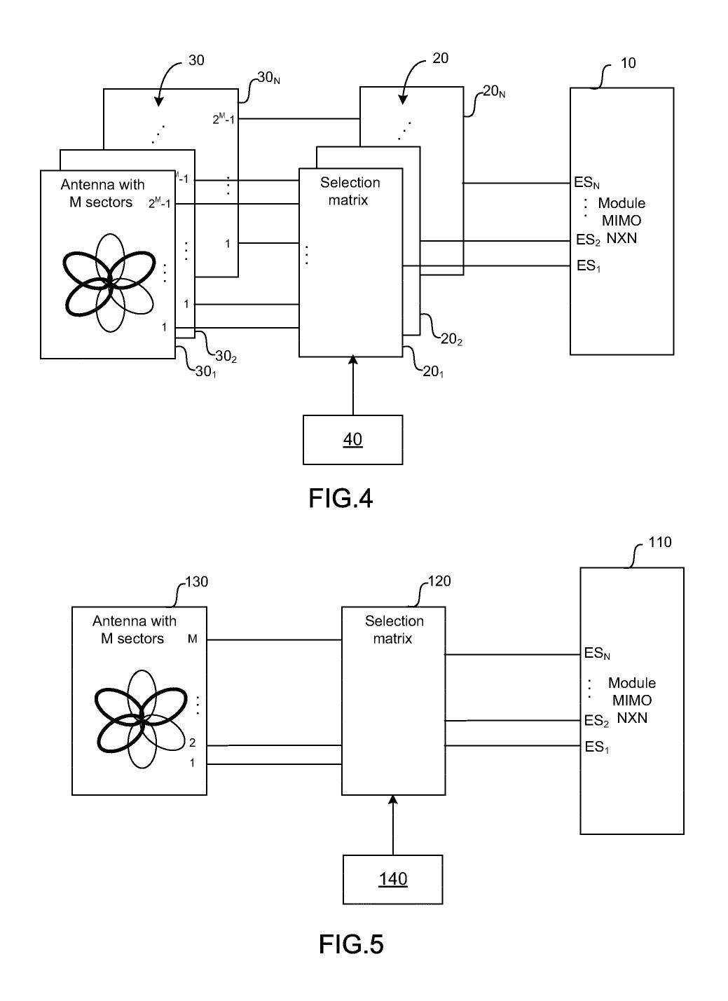

In reference to FIG. 4, the invention device includes:
a MIMO module 10 consisting of N inputs/outputs ES₁ . . . ES_{N} to deliver or receive N signals, N being greater than or equal to 2,
an antenna system 30 consisting of N multi-sector antennas 30₁ . . . 30_{N} for transmitting or receiving N signals, each antenna consisting of M angular sectors, and
switching means 20 mounted between the antenna system and the MIMO module and consisting of N switching circuits 20₁ . . . 20_{N}.

Each input/output ESᵢ of the MIMO module is connected to inputs/outputs of the antenna 30ᵢ via the switching circuit 20ᵢ, with iε[1 . . . N] The inputs/outputs of the antenna 30ᵢ, which are connected to the output ESᵢ of the MIMO module, are selected using a switching diagram implemented by the switching circuit 20ᵢ. This diagram is determined using control means 40 according to a signal reception quality criterion.

Each antenna 30ᵢ includes, in plane H, M angular sectors sensitively not overlapping each other and together forming a global angular sector of 360 degrees. Each antenna 30ᵢ is capable of selectively transmitting or receiving signals in P angular sectors, where 1≦P<M. Each angular sector or combination of angular sectors corresponds to a specific radiation diagram.

Each antenna 30ᵢ also includes Q=2^{M}−1 inputs, each one connected to a specific combination of angular sectors from the 2^{M}−1 possible combinations of angular sectors of the antenna. Inputs/outputs that are not connected to any sector are excluded.

The P angular sectors through which the MIMO signal associated with the input ESᵢ is transmitted or received are selected using the switching circuit 20ᵢ according to a switching diagram determined using control means. The switching circuit 20ᵢ is used to connect the ESᵢ input/output with the input/output of antenna 30ᵢ, which is connected to the selected P angular sectors.

The switching diagram used by the switching circuit 20ᵢ is determined using control means 40. These control means 40 may be included in the MIMO module 10. This is determined using an algorithm based on MIMO signal reception quality used by the device if concerned with a transmission/reception device or by the MIMO signal reception device if the present device is only a MIMO signal transmission device. The signal reception quality can be defined using one or more values provided by the MIMO value, particularly the RSSI (Received Signal Strength Indication) value, the SINR (Signal to Interference plus Noise Ratio) value, the BER (Bit Error Rate) and the PER (Packet Error Rate).

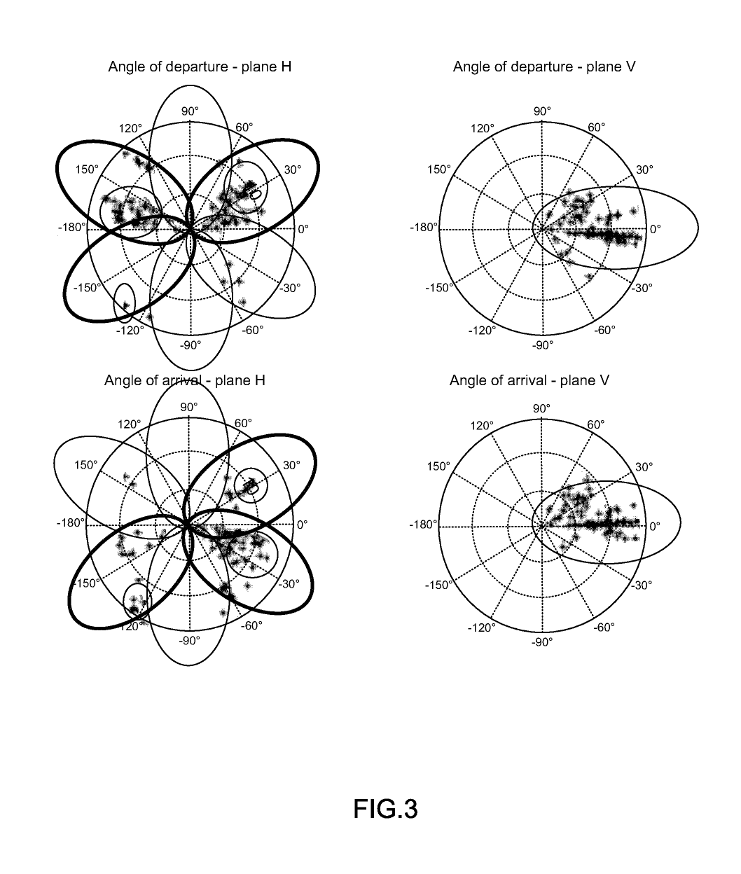

As can be seen in FIGS. 2 and 3, the number of prioritized signal propagation directions in plane H is generally reduced. In the example of FIGS. 2 and 3 corresponding to an antenna with 6 angular sectors in plane H, this number of prioritized directions is equal to 3 in plane H. To simplify the switching circuits and reduce the number of inputs/outputs of each antenna 30ᵢ, it is possible to provide the simultaneous connection of up to D inputs/outputs of antenna 30ᵢ at the input/output ESᵢ of the MIMO module, D being the maximum number of prioritized directions permitted. It is considered, for example, that D will be less than or equal to 3 or 4. The number of inputs/outputs of antenna 30ᵢ can then be reduced to

$${\sum }_{A = 1}^{D} \frac{M !}{A ! ( M - A ) !} ,$$

each input/output being connected to up to D angular sectors, and the number of switching diagrams that switching circuit 20ᵢ must implement can also be reduced to

$${\sum }_{A = 1}^{D} \frac{M 1}{A ! ( M - A ) !} .$$

The invention device can be simplified to further reduce its cost, as illustrated in FIG. 5. In this figure, the device consists of just one multi-sector antenna 130, with M angular sectors where M>N, which is connected to an MIMO module 110 via a single switching circuit 120. The MIMO module 110 consists of N inputs/outputs ESᵢ and antenna 130 includes M inputs/outputs each connected to a specific angular sector from the M angular sectors. The switching circuit 120 connects the N inputs/outputs ESᵢ with N inputs/outputs of antenna 130 according to a switching circuit selected using control means 140. In this embodiment, each of the N MIMO signals is received or transmitted via its own angular sector from the M angular sectors of antenna 130. The angular sectors selected by the control methods 140 each correspond to a prioritized signal propagation direction. In the case of a 2×2 MIMO module, the 2 MIMO signals are each transmitted or received in its own angular sector corresponding to a prioritized signal propagation direction. The control means 140 must then have at least two prioritized directions determined.

Regardless of the embodiment (FIG. 4 or FIG. 5), the antenna 30ᵢ or 130 includes at least M=4 angular sectors, preferably M=6 angular sectors.

In the M=6 case, the width of the angular sectors is about 60° in the horizontal plane and between −30° and +30° in the vertical plane (or elevation plane).

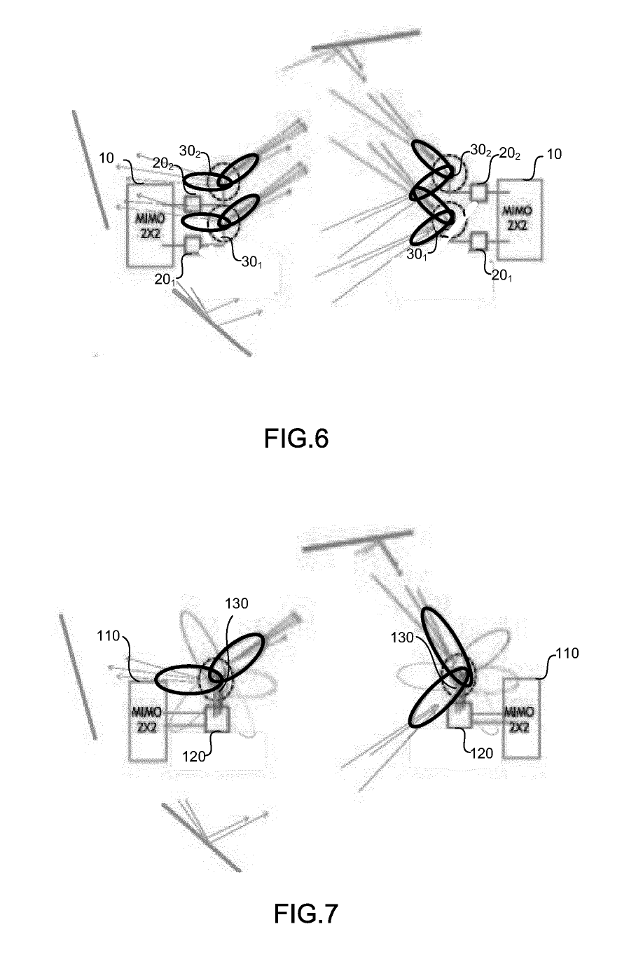

FIGS. 6 and 7 illustrate the functioning of a system containing transmission and reception devices in accordance with FIG. 4 (respectively FIG. 5). These devices include 2×2 MIMO modules (N=2) and antennas with 6 angular sectors (M=6). Two prioritized propagation directions corresponding to two clusters have been identified. The angular sectors selected by the devices correspond to these clusters.

The angular sectors used by the devices in FIG. 7 are, for example, selected in the following way. A and B indicate the two system devices. This selection comprises two steps:
during the first step, device B transmits learning symbols through each of the possible configurations (or combinations) of N sectors from M angular sectors; device A listens for the learning symbols transmitted by device B and determines, for each configuration of N sectors from M transmission sectors (device B) and each configuration of N sectors from N reception sectors (device A), a quality indicator (RSSI or SINR or BER or PER); in total,

$${[ \frac{M !}{N ! ( M - N ) !} ]}^{2}$$

quality indicators are determined; the configuration showing the highest quality indicator is selected for device A in order to communicate with device B;
during the second step, device A transmits learning signals with the configuration selected during the first step; device B listens for the learning symbols transmitted by device A and determines a quality indicator (RSSI or SINR or BER or PER) for each possible configuration of N sectors from M reception sectors;

$$\frac{M !}{N ! ( M - N ) !}$$

quality indicators are then determined and the configuration showing the highest quality indicator is selected for device B in order to communicate with device A. It should be noted that the SINR indicator appears to be the most suitable indicator in an environment dominated by interferences.

The second step or both steps can be repeated periodically in order to take into account changes in the propagation environment. As an alternative, in order to reduce the frequency of system reconfigurations (frequency of learning procedure launches), it may be decided to maintain the configurations of devices A and B while the transmission channel varies slightly, in other words so that the quality indicator does not fall below a predefined limit.

It should be noted that the invention device is capable of functioning with a classic device consisting of a conventional omnidirectional antenna, a portable device, for example. If A indicates the invention device and B indicates the classic device, the learning phase takes place as follows. Device A listens for the learning symbols transmitted by device B through its omnidirectional antenna and determines, for each configuration (or combination) of N sectors from M sectors, a quality criterion (RSSI or SINR or BER or PER).

$$\frac{M !}{N ! ( M - N ) !}$$

quality indicators are thus determined and the configuration with the highest quality indicator is selected for device A in order to communicate with device B.

When device A or B include N multi-sector antennas and N switching circuits (FIGS. 4 and 6), the learning is carried out as before except that the

$$\frac{M !}{N ! ( M - N ) !}$$

configurations are tested via the N antennas and the N switching circuits.

Compared with the existing MIMO devices consisting of omnidirectional antennas and using the beamforming technique, the invention device provides the following advantages:
the interference rate is reduced in the front radio channel (directive antennas) and reduces the risk of saturation or disturbance of the radio channels of the MIMO module,
the number of MIMO channels (=N) can be limited by a “smart” selection of the selected angular sectors and reduce the total consumption of the device.

Moreover, as the invention device consists of N multi-sector antennas and N switching circuits (corresponding to FIGS. 4 and 6), signal transmission is also improved. The expected gain is equal to around GTx+GRx, where GTx corresponds to the gain in transmission and GRx corresponds to the gain in reception.

With respect to the invention device consisting of 1 sole antenna and 1 sole switching circuit, the expected gain is lower, in the order of GTx+GRx-10 log N, N being the number of MIMO chains, but the structure of the device is less complex.

Although the invention has been described in relation to different particular embodiments, it is obvious that it is in no way restricted and that it comprises all the technical equivalents of the means described together with their combinations if the latter fall within the scope of the invention.

1. Device for the transmission and/or reception of signals in a MIMO system comprising:
a MIMO module comprising N inputs/outputs to deliver or receive N signals, N being greater than or equal to 2;
an antenna system to transmit or receive said N signals, wherein the antenna system comprises at least one multi-sector antenna, with M angular sectors in a horizontal plane capable of selectively receiving and/or transmitting said N signals in one or more of said M angular sectors where M>N,
and in that the device further comprises a switching device, mounted between the MIMO module and the antenna system, to connect P angular sectors of the at least one multi-sector antenna, with 1≦P<M, with each of the N inputs/outputs of the MIMO module according to a switching diagram determined using a controller in accordance with a criteria representing the quality of the reception of signals by said device or another device.

2. Device according to claim 1, wherein the antenna system comprises N multi-sector antennas with M angular sectors and the switching of device comprises N switching circuits, each input/output of the MIMO module being connected to one of said N multi-sector antennas via one of said N switching circuits.

3. Device according to claim 2, wherein each of said N multi-sector antennas includes Q inputs/outputs, Q being less than or equal to 2^{M}−1, each of said Q inputs/outputs being connected to a specific combination of angular sectors of the multi-sector antenna.

4. Device according to claim 2, wherein, for each multi-sector antenna, up to D angular sectors are connected via a switching circuit to a MIMO module input/output, where D<M.

5. Device according to claim 4, in which each of said N multi-sector antennas includes Q inputs/outputs, Q being equal to
$${\sum }_{A = 1}^{D} \frac{M !}{A ! ( M - A ) !} ,$$
each of said Q inputs/outputs being connected to a specific combination of angular sectors of the multi-sector antenna.

6. Device according to claim 4 wherein M is at least equal to 4 and D is at least equal to 3.

7. Device according to claim 1, wherein the antenna system comprises a multi-sector antenna with M angular sectors, where M>N, and the switching device comprises a switching circuit, said multi-sector antenna comprising M inputs/outputs, each input/output being connected to an angular sector of said antenna, said switching circuit being configured to selectively connect N antenna inputs/outputs to N inputs/outputs of the MIMO module.

8. Device according to claim 1, wherein M is equal to 6, each angular sector presenting an opening of around 60° in the horizontal plane.

9. Device according to claim 1, wherein the M angular sectors of the at least one multi-sector antenna present identical openings in a vertical plane.

10. Device according to claim 9, wherein the M angular sectors each present an opening of up to 120° between −60° and +60° in the vertical plane, preferably an opening of 60° inclusive between the angles −30° and +30° in the vertical plane.
